(19) United States
(12) Patent Application Publication
(10) Pub. No.: US 2026/0011077 A1
(43) Pub. Date: Jan. 8, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: YOSUKE EGUCHI, Tokyo (JP); KANJI SUZUKI, Kanagawa (JP)

(21) Appl. No.: 19/245,617

(22) Filed: Jun. 23, 2025

(30) Foreign Application Priority Data
Jul. 2, 2024 (JP) 2024-106670

(51) Int. Cl. G06T 17/00; G06T 7/11

(52) U.S. Cl. CPC G06T 17/00; G06T 7/11; G06T 2207/20021; G06T 2207/20024

(57) ABSTRACT

An image processing apparatus comprises a region division unit configured to divide an image into a plurality of regions by classifying objects; a filter processing unit configured to perform, with respect to respective distance information corresponding to the plurality of regions of the image, filter processing having different characteristics according to the classification; a synthesis unit configured to synthesize the distance information on which the filter processing has been performed; and a 3D data generation processing unit configured to generate 3D data of a subject based on the distance information synthesized by the synthesis unit and the image.

### BACKGROUND

### Field of the Technology

The present disclosure relates to an image processing apparatus, an image processing method, a storage medium, and the like.

### Description of the Related Art

For example, in Japanese Patent Application Laid-Open No. 2024-8596, an image processing apparatus is described that can generate a stereoscopic image by processing an image based on distance information, wherein the distance information is acquired simultaneously when capturing a still image.

However, in such technology, generally, although a smoothing (median) filter is applied for removing noise of distance data, when the tap number of the filter is increased, organs (eyes, nose, and mouth), accessories, and asperities of hair cannot be reproduced. Conversely, when the tap number of the filter is decreased, there was an issue wherein noise tended to remain on skin having low texture.

### SUMMARY

An image processing apparatus according to one embodiment of the present disclosure comprises a region division unit configured to divide an image into a plurality of regions by classifying objects; a filter processing unit configured to perform, with respect to respective distance information corresponding to the plurality of regions of the image, filter processing having different characteristics according to the classification; a synthesis unit configured to synthesize the distance information on which the filter processing has been performed; and a 3D data generation processing unit configured to generate 3D data of a subject based on the distance information synthesized by the synthesis unit and the image.

Further features of the present disclosure will become apparent from the following description of embodiments with reference to the attached drawings.

### BRIEF DESCRIPTION OF THE DRAWINGS

FIG. 1 is a functional block diagram showing a configuration example of an image capturing apparatus 100 according to a First Embodiment of the present disclosure.

FIG. 2A and FIG. 2B are diagrams exemplifying a detailed configuration of an image capturing element 2 of the image capturing apparatus 100 according to the First Embodiment of the present disclosure.

FIG. 3A is a schematic diagram showing an exit pupil 304 of an optical system 1 and a light flux received by a first photoelectric conversion unit 215 of a pixel of the image capturing element 2, and FIG. 3B is a schematic diagram showing a light flux received by a second photoelectric conversion unit 216 in the same manner.

FIG. 4A to FIG. 4C are schematic diagrams showing a relationship of the image capturing element 2 and the optical system 1 of the image capturing apparatus 100 according to the First Embodiment of the present disclosure.

FIG. 5 is a flowchart showing an example of 3D data generation processing by an image processing unit 3 of the image capturing apparatus 100 according to the First Embodiment of the present disclosure.

FIG. 6A is a diagram showing an example of an image obtained in step S20, FIG. 6B is a diagram showing an example of a distance map, FIG. 6C is a diagram showing an example of a mesh image generated based on point cloud data, and FIG. 6D is a diagram showing an example of a texture image generated based on the mesh image of FIG. 6C.

FIG. 7 is a flowchart for explaining an example of smoothing processing in step S505.

FIG. 8A is a flowchart showing an example of smoothing processing of step S505 according to the First Embodiment of the present disclosure, FIG. 8B is a diagram for explaining an example of types of regions in step S801 of FIG. 8A. FIG. 8C is a diagram for explaining an example of changing a smoothing filter size in step S802 of FIG. 8A.

FIG. 9 is a flowchart showing an example of smoothing processing of step S505 according to a Second Embodiment of the present disclosure.

FIG. 10 is a flowchart showing an example of smoothing processing of step S505 according to a Third Embodiment of the present disclosure.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

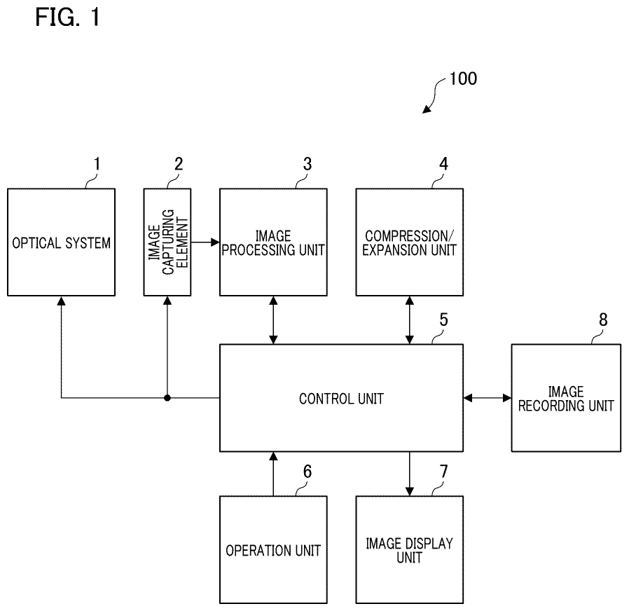

FIG. 1 is a diagram showing a configuration example of an image capturing apparatus 100 according to the First Embodiment of the present disclosure. It should be noted that a part of the functional blocks shown in FIG. 1 is realized by executing a computer program stored in a memory serving as a storage medium (not shown) on a CPU and the like serving as a computer (not shown) included in the image capturing apparatus 100.

However, a part or all of those functional blocks may be realized using hardware. As for hardware, a dedicated circuit (ASIC) or processors (reconfigurable processor, DSP) and the like can be used. In addition, the respective functional blocks shown in FIG. 1 need not be built into the same housing, and may be configured by separate apparatuses connected to each other via a signal path.

The image capturing apparatus 100 is applicable to a digital still camera, a digital video camera, an in-vehicle camera, a surveillance camera, a smartphone, and the like. The image capturing apparatus 100 comprises an optical system 1, an image capturing element 2, an image processing unit 3, a compression/expansion unit 4, a control unit 5, an operation unit 6, an image display unit 7, and an image recording unit 8. It should be noted that the image capturing apparatus 100 in the present embodiment functions as an image processing apparatus.

The optical system 1 is provided with a lens, a lens driving mechanism, a mechanical shutter mechanism, an aperture mechanism, and the like. Movable units of these components are driven based on a control signal from the control unit 5.

The image capturing element 2 is, for example, a CMOS (Complementary Metal Oxide Semiconductor) image sensor of an XY address type, and performs image capturing operation according to a control signal from the control unit 5. Furthermore, an image capturing signal is digitized by an AD conversion circuit included in the image capturing element 2, and is output to the image processing unit 3 as an image signal.

It should be noted that in each pixel of the image capturing element 2 of the present embodiment, for example, a first photoelectric conversion unit and a second photoelectric conversion unit are arranged side by side. In addition, a common microlens is disposed on the light incident surfaces of the first photoelectric conversion unit and the second photoelectric conversion unit. Thereby, light from a different exit pupil of an image capturing lens included in the optical system 1 is incident on the first photoelectric conversion unit, and light from another different exit pupil of the image capturing lens is incident on the second photoelectric conversion unit.

Accordingly, a first image signal obtained from a group of the first photoelectric conversion units of a plurality of pixels and a second image signal obtained from a group of the second photoelectric conversion units of a plurality of pixels have parallax. It should be noted that the image capturing element 2 can read out a signal obtained by adding signals of the first photoelectric conversion unit and the second photoelectric conversion unit for each pixel as image data for display.

In addition, the image capturing element 2 may be configured to output the first image signal and the second image signal separately, for example, or alternatively, the image capturing element 2 may be configured to separately read out the above-described image data added for each pixel and the above-described first image signal. Thereby, in the image processing unit 3 in a subsequent stage, the second image signal can be calculated by subtracting the first image signal from the above-described added image data.

The image processing unit 3 generates a distance image (distance map) by calculating distance information to a subject based on a correlation distance (phase difference) between the above-described first image signal and second image signal obtained from the image capturing element 2. In addition, the image processing unit 3 generates a stereoscopic image (3D data) based on the image signal and the distance image (distance map) as described below. It should be noted that details of a configuration example of the image capturing element 2 and details of a calculation method of the distance information will be described below.

It should be noted that the image processing unit 3, under control of the control unit 5, also performs image processing such as noise correction, white balance processing, and the like on a digitized image signal input from the image capturing element 2. In addition, the image processing unit 3 generates a control signal for controlling a focus lens of the optical system 1 based on the above-described distance information, and generates a control signal for controlling an accumulation time of the image capturing element and an aperture based on luminance information of the image signal.

An image signal and control information that have been subjected to image processing in the image processing unit 3 are output to the control unit 5. It should be noted that at least a part of image processing for generating a stereoscopic image may be performed in an external image processing apparatus separate from the image capturing apparatus 100.

The compression/expansion unit 4 operates under control of the control unit 5, and performs compression encoding processing of the image signal, or performs expansion decoding processing of encoded data of a still image. In addition, the compression/expansion unit 4 may execute compression encoding/expansion decoding processing of a moving image.

The control unit 5 is a microcontroller configured by, for example, a CPU (Central Processing Unit), a ROM (Read Only Memory), a RAM (Random Access Memory), and the like.

The CPU serving as a computer of the control unit 5 comprehensively controls each part of the entire image capturing apparatus 100 by executing a computer program stored in a storage medium such as a ROM. The operation unit 6 is configured by various operation members such as a shutter release button and the like, and outputs a control signal according to an input operation by a user to the control unit 5.

As examples of input operations by a user, setting of a recording mode of a still image or a moving image and the like, and exposure control (aperture, accumulation time of the image capturing element, ISO sensitivity) and the like are possible.

The image display unit 7 causes the display device to display an image by supplying an image signal to a display device such as an LCD (Liquid Crystal Display) and the like. The image recording unit 8, for example, has a portable recording medium connected thereto, and stores a compressed and encoded image data file.

It should be noted that in the image recording unit 8, a distance image (distance map) may be additionally recorded in association with an image data file. Alternatively, in the image recording unit 8, the first image signal and the second image signal may be recorded as an image data file. Alternatively, in the image recording unit 8, the image data for display added for each pixel and the first image signal may be recorded, and the second image signal can be calculated later.

By performing as described above, a stereoscopic image can be generated by reading out an image data file and a distance image (distance map) and the like from the image recording unit 8 at any timing after image capturing. It should be noted that the image capturing apparatus 100 may have a communication unit, and can, for example, transmit image data and a distance image (distance map) and the like recorded in the image recording unit 8 to an external image processing apparatus and the like. Accordingly, 3D data (stereoscopic image) can be generated in the external image processing apparatus.

In this context, the optical system 1 is an image capturing lens provided in the image capturing apparatus 100, and forms an optical image of a subject on an image capturing plane of the image capturing element 2. The optical system 1 is configured by a plurality of lenses (not shown) arranged on an optical axis 303, and has an exit pupil 304 at a position separated from the image capturing element 2 by a predetermined distance.

It should be noted that in the present specification, a direction parallel to the optical axis 303 is defined as a z direction or a depth direction, a direction orthogonal to the optical axis 303 and parallel to a horizontal scanning direction of an image signal of the image capturing element 2 is defined as an x direction, and a direction parallel to a vertical scanning direction of the image signal is defined as a y direction, or such axes are provided.

In addition, in the present embodiment, the image capturing element 2 is configured so as to be capable of obtaining an image group used for rangefinding of an image capturing plane phase-difference detection rangefinding method.

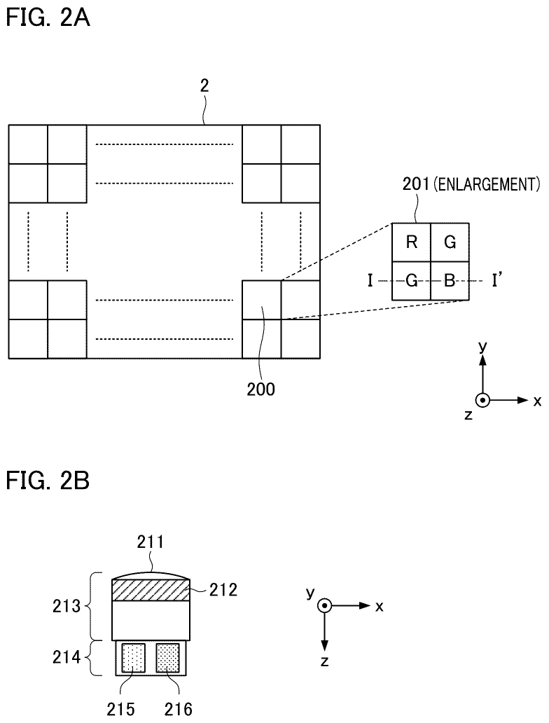

FIG. 2A and FIG. 2B are diagrams exemplifying a detailed configuration of an image capturing element 2 included in the image capturing apparatus 100 according to the First Embodiment of the present disclosure. The image capturing element 2 is, as shown in FIG. 2A, configured by a plurality of pixel groups 201 having two rows and two columns, to which different color filters have been applied, being connected in an array.

As illustrated in the enlarged view, the pixel group 201 consisting of four pixels has red (R), green (G), and blue (B) color filters arranged, and an image signal indicating color information of either R, G, or B is output from each pixel. It should be noted that in the present embodiment, as an example, although the color filters are explained as being in a Bayer array as shown, the color filter array is not limited thereto.

FIG. 2B is a diagram showing an example of an I-I′ cross-section of FIG. 2A. In order to realize a rangefinding function of an image capturing plane phase-difference detection rangefinding method, in the image capturing element 2 of the present embodiment, one pixel has a plurality (for example, two) of photoelectric conversion units arranged side by side in a horizontal scanning direction (x direction) of the image capturing element 2, as depicted in FIG. 2B.

That is, each pixel of the image capturing element 2 is, as shown in FIG. 2B, configured by a light guide layer 213 including a microlens 211 and a color filter 212, and a light receiving layer 214 including a first photoelectric conversion unit 215 and a second photoelectric conversion unit 216.

In the light guide layer 213, the microlens 211 is configured so as to efficiently guide the light flux incident on a pixel to the first photoelectric conversion unit 215 and the second photoelectric conversion unit 216. In addition, the color filter 212 transmits only light in any of the above-described R, G, or B wavelength bands, and guides the light to the first photoelectric conversion unit 215 and the second photoelectric conversion unit 216.

The first photoelectric conversion unit 215 and the second photoelectric conversion unit 216 that convert the received light into an analog image signal are provided in the light receiving layer 214, and two types of signals output from these two photoelectric conversion units are used for rangefinding.

That is, each pixel of the image capturing element 2 has two photoelectric conversion units arranged in the horizontal scanning direction in the same manner. In addition, a first image signal configured by signals output from a group of the first photoelectric conversion units 215 among all pixels and a second image signal configured by signals output from a group of the second photoelectric conversion units 216 are used.

The first photoelectric conversion unit 215 and the second photoelectric conversion unit 216 each partially receive the light flux incident on the pixel via the microlens 211, and therefore, each photoelectric conversion unit receives a light flux that has passed through different pupil regions of the exit pupil of the optical system 1.

That is, the image capturing element 2 is capable of capturing two image signals, each having parallax, that have passed through different pupil regions of the optical system 1. Here, a composite of photoelectric conversion signals in the first photoelectric conversion unit 215 and the second photoelectric conversion unit 216 in each pixel can be used as an image signal for display.

It should be noted that in the present embodiment, the image capturing element 2 is configured to be capable of separate output of an image signal for display (an image signal obtained by adding, for each pixel, the signals from the first photoelectric conversion unit 215 and the second photoelectric conversion unit 216) and an image signal for rangefinding (at least one of the first image signal and the second image signal).

It should be noted that in the present embodiment, although an example is explained in which all pixels of the image capturing element 2 are provided with two photoelectric conversion units and are configured to be capable of output of high-density depth information, the present embodiment is not limited thereto. For example, the number of photoelectric conversion units included in each pixel may be three or more, or pixels provided with a plurality of photoelectric conversion units may be limited to only a part of the pixels of the image capturing element 2.

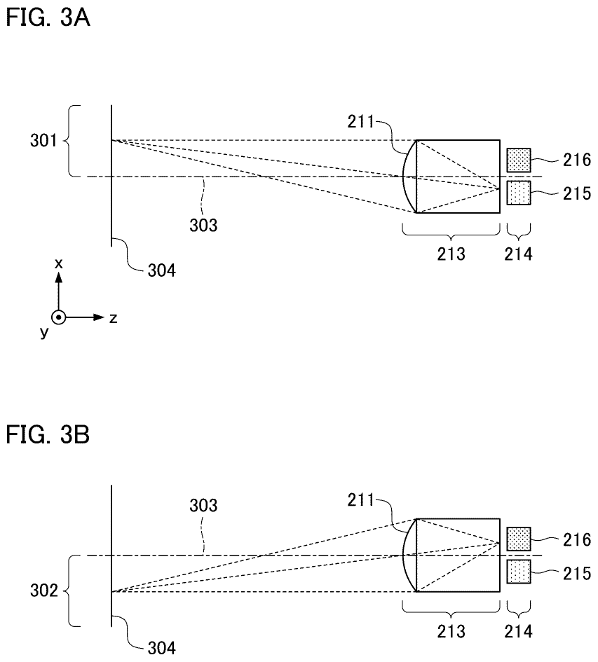

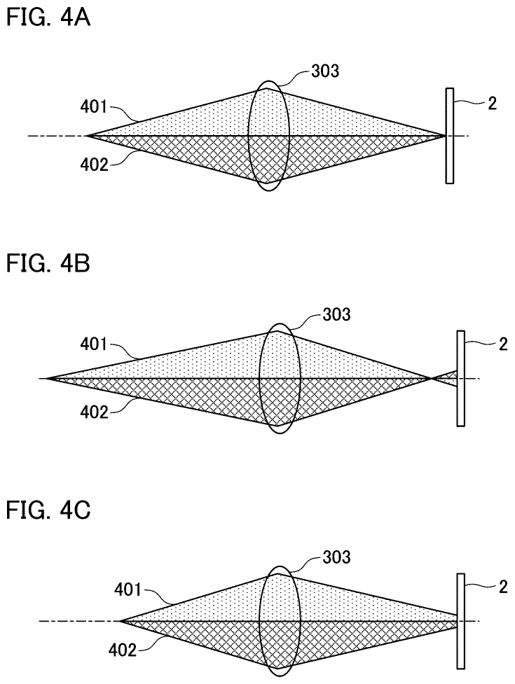

Next, with reference to FIG. 3 and FIG. 4, an explanation will be provided with respect to a principle of measuring a subject distance based on the first image signal output from a group of the first photoelectric conversion units 215 and the second image signal output from a group of the second photoelectric conversion units 216.

FIG. 3A is a schematic diagram showing a light flux received by the first photoelectric conversion unit 215 of a pixel in the image capturing element 2 and the exit pupil 304 of the optical system 1. Similarly, FIG. 3B is a schematic diagram showing a light flux received by the second photoelectric conversion unit 216.

The microlens 211 shown in FIG. 3A and FIG. 3B is disposed so that the exit pupil 304 and the light receiving layer 214 are in an optically conjugate relationship. The light flux that has passed through the exit pupil 304 of the optical system 1 is focused by the microlens 211 and is guided to the first photoelectric conversion unit 215 or the second photoelectric conversion unit 216.

At this time, as shown in FIG. 3A and FIG. 3B, the first photoelectric conversion unit 215 and the second photoelectric conversion unit 216 each mainly receive light fluxes that have passed through different pupil regions. That is, a light flux that has passed through a first pupil region 301 within the exit pupil 304 is incident on the first photoelectric conversion unit 215, and a light flux that has passed through a second pupil region 302 within the exit pupil 304 is incident on the second photoelectric conversion unit 216.

A plurality of the first photoelectric conversion units 215 provided in the image capturing element 2 mainly receive light fluxes that have passed through the first pupil region 301, and output the first image signal. At the same time, a plurality of the second photoelectric conversion units 216 provided in the image capturing element 2 mainly receive light fluxes that have passed through the second pupil region 302, and output the second image signal.

From the first image signal, an intensity distribution of an image formed on the image capturing element 2 by the light flux that has passed through the first pupil region 301 can be obtained. In addition, from the second image signal, an intensity distribution of an image formed on the image capturing element 2 by the light flux that has passed through the second pupil region 302 can be obtained.

A relative positional displacement amount between the first image signal and the second image signal (so-called phase difference or parallax amount) becomes a value according to a defocus amount. The relationship between the parallax amount and the defocus amount will be explained by using FIG. 4A to FIG. 4C.

FIG. 4A to FIG. 4C are schematic diagrams showing a relationship of the image capturing element 2 and the optical system 1 according to the First Embodiment. Reference sign 401 in the diagram indicates a first light flux passing through the first pupil region 301, and reference sign 402 indicates a second light flux passing through the second pupil region 302.

FIG. 4A shows an in-focus state, and the first light flux 401 and the second light flux 402 converge on the image capturing element 2. At this time, the parallax amount between the first image signal formed by the first light flux 401 and the second image signal formed by the second light flux 402 becomes zero.

FIG. 4B shows a state of defocus in the negative direction of the z-axis on the image side. At this time, the parallax amount between the first image signal formed by the first light flux 401 and the second image signal formed by the second light flux 402 has a negative value.

FIG. 4C shows a state of defocus in the positive direction of the z-axis on the image side. At this time, the parallax amount between the first image signal formed by the first light flux 401 and the second image signal formed by the second light flux 402 has a positive value.

From the comparison between FIG. 4B and FIG. 4C, it is apparent that the direction of the positional displacement is switched according to whether the defocus amount is positive or negative. Furthermore, it is apparent that the positional displacement occurs in accordance with an image formation relationship (geometric relationship) of the optical system 1 according to the defocus amount. The parallax amount, which is the positional displacement between the first image signal and the second image signal, can be detected by region-based matching processing.

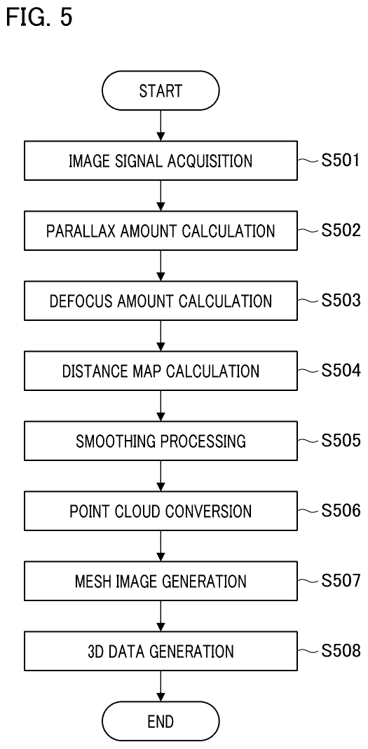

FIG. 5 is a flowchart showing an example of 3D data generation processing by the image processing unit 3 of the image capturing apparatus 100 according to the First Embodiment of the present disclosure. It should be noted that operations of each step in the flowchart of FIG. 5 and other flowcharts in the description below are sequentially performed by a CPU and the like serving as a computer of the control unit 5 executing a computer program stored in a memory.

The processing flow of FIG. 5 starts, for example, in a case in which an instruction for generation of a stereoscopic image is input via the operation unit 6.

In step S501, an image signal is acquired from the image capturing element 2 or the image recording unit 8. In this context, the image signal includes, for example, an image signal for display and at least one of the first image signal or the second image signal.

That is, in the present context, the image capturing element is configured so as to read out an image signal for display and one of the first image signal or the second image signal. In addition, an image signal for display and one of the first image signal or the second image signal are recorded in the image recording unit 8.

Then, in step S501, the second image signal is acquired by subtracting, for example, the first image signal from the image signal for display. In this manner, the first image signal and the second image signal are finally acquired in step S501.

It should be noted that the image capturing element may be configured so that the first image signal and the second image signal can be separately read out from the image capturing element, or the image recording unit may be configured so that the first image signal and the second image signal can be separately read out from the image recording unit. Thereby, the first image signal and the second image signal may be acquired in step S501.

Next, in step S502, the image processing unit 3 calculates a parallax amount between these images based on the first image signal and the second image signal. Specifically, the image processing unit 3 sets, in the first image signal, a point of interest corresponding to representative pixel information and a verification region centered on the point of interest.

The verification region may be, for example, a rectangular region such as a square region having a predetermined length on one side centered on the point of interest. Next, the image processing unit 3 sets a reference point in the second image signal, and sets a reference region centered on the reference point.

The reference region has the same size and shape as the above-described verification region. The image processing unit 3 derives a degree of correlation between the image included in the verification region of the first image signal and the image included in the reference region of the second image signal while sequentially moving the reference point, and identifies the reference point having the highest degree of correlation as a corresponding point corresponding to the point of interest in the second image signal. A relative positional displacement amount between the corresponding point identified in this manner and the point of interest becomes the parallax amount at the point of interest.

In step S502, the image processing unit 3 derives the parallax amount at a plurality of pixel positions determined by the representative pixel information by calculating the parallax amount in this manner while sequentially changing the point of interest according to the representative pixel information.

Next, in step S503, a defocus amount is calculated based on the parallax amount calculated in step S502. That is, the parallax amount is converted into a defocus amount, which is a distance from the image capturing element 2 to a focal point of the optical system 1, by using a predetermined conversion coefficient.

That is, assuming a predetermined conversion coefficient as K and a defocus amount as ΔL, the parallax amount can be converted into a defocus amount by:

ΔL=K×d

Furthermore, in step S504, a distance map is calculated. That is, the defocus amount ΔL described above is converted into a subject distance for each pixel by using the lens formula in geometric optics:

1/A+1/B=1/F

In this context, A is defined as a distance (subject distance) from an object surface of the subject to a principal point of the optical system 1, B is defined as a distance from the principal point of the optical system 1 to an image plane, and F is defined as a focal length of the optical system 1. That is, in the above-mentioned lens formula, because a value of B can be derived from the defocus amount ΔL, the subject distance A from the optical system 1 to the object surface can be derived based on the setting of the focal length at the time of image capturing.

In this manner, the image processing unit 3 generates two-dimensional information (distance map) having the subject distance derived in step S504 as a pixel value, and stores the two-dimensional information in the image recording unit 8 or a memory and the like in the control unit 5. In this context, steps S501 to S504 function as an information acquisition step (information acquisition unit) of acquiring the image and distance information (distance map).

It should be noted that the information acquisition step (information acquisition unit) may acquire the image and distance information (distance map) from the image capturing element, or may acquire the image and distance map from the image recording unit.

Thereafter, in step S505, smoothing processing for noise reduction of the distance map is performed. It should be noted that details of the smoothing processing in step S505 will be described below. Next, 3D data generation processing is performed in steps S506 to S508.

That is, processing for generating a stereoscopic image is performed based on image data and distance image (distance map) and the like. It should be noted that 3D data in the present embodiment means a stereoscopic image viewable from the front-facing position to positions within a predetermined rotation angle range.

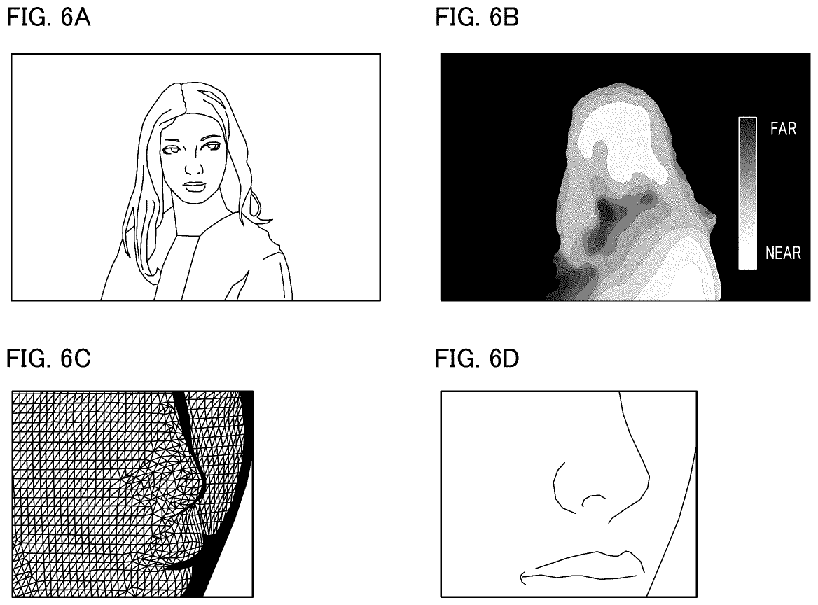

FIG. 6A is a diagram showing an example of an image obtained in step S501, and FIG. 6B is a diagram showing an example of a distance map obtained in step S504. In FIG. 6B, a higher grayscale density indicates a farther distance.

In step S506 of FIG. 5, point cloud conversion is performed based on data of the distance map, and point cloud data is obtained. Furthermore, in step S507, a mesh image is generated based on the point cloud data. FIG. 6C is a diagram showing an example of a mesh image generated based on the point cloud data.

In step S508, 3D data is generated by generating a texture image by associating a position of an image acquired in step S501 with a position of a mesh image generated in step S507.

In this context, steps S506 to S508 function as a 3D data generation processing step (3D data generation processing) of generating 3D data of the subject based on the distance map and the image acquired in step S501.

FIG. 6D is a diagram showing an example of a texture image generated based on the mesh image of FIG. 6C. This texture image is output as 3D data. When the processing of step S508 is completed, the processing flow of FIG. 5 is ended, and the 3D data generated by step S508 is recorded in, for example, the image recording unit 8.

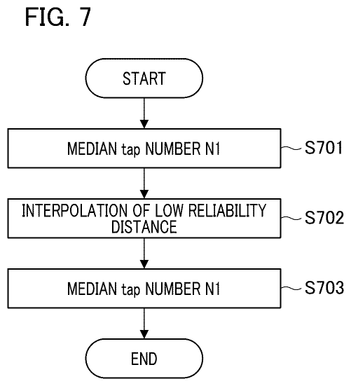

Next, FIG. 7 is a flowchart for explaining an example of smoothing processing in step S505. In step S701, median filter processing having a tap number of N1 is performed, for example. Thereby, errors in the distance map calculated in step S504 are reduced.

Next, in step S702, interpolation processing of low reliability distance data is performed. That is, in the distance map in which noise has been reduced in step S701, distance data having low reliability is interpolated by surrounding distance data.

After step S703, for example, median processing having a tap number of N1 is performed again. The median processing is for reducing a step difference between a region of distance data having low reliability and a region other than the region of distance data having low reliability by the interpolation processing of step S702.

In this manner, by executing processing of steps S701 to S703, noise of distance data in the distance map can be reduced while the low reliability region is interpolated by distance data around the low reliability region, and furthermore, a step difference generated thereby can be reduced.

However, in the processing flow shown in FIG. 7, for example, when the median filter in step S701 or step S703 is strengthened (for example, when the tap number is increased to N3 (N3>N1) and the like), organs, accessories, and asperities of hair may not be reproduced. In contrast, when the filter is weakened (for example, the tap number is reduced), noise tends to remain on skin having low texture, and moreover, skin around bangs or glasses may protrude.

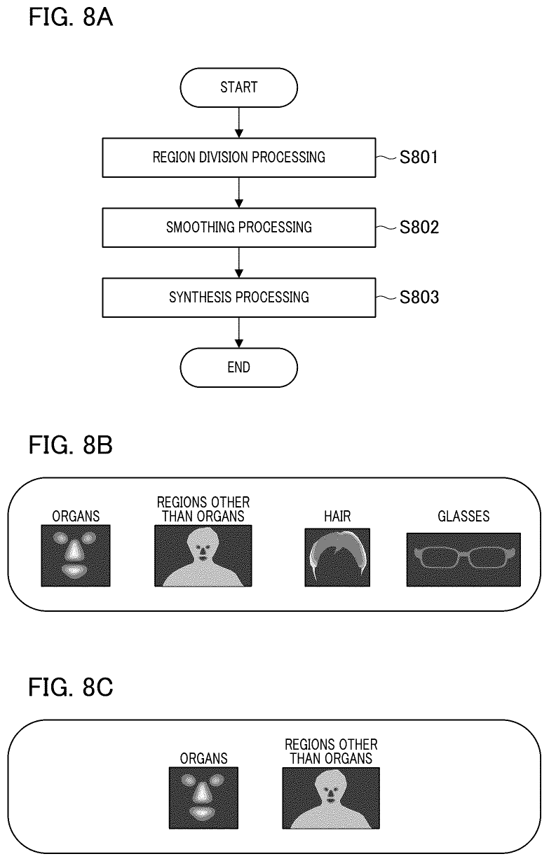

FIG. 8A is a flowchart showing an example of smoothing processing of step S505 according to the First Embodiment of the present disclosure, and FIG. 8B is a diagram for explaining an example of types of regions in step S801 of FIG. 8A. In addition, FIG. 8C is a diagram for explaining an example of changing a smoothing filter size in step S802 of FIG. 8A.

It should be noted that in the example of FIG. 8A, a filter processing unit performs filter processing having different characteristics for each distance information (region of distance map) corresponding to regions of an image that has been classified by switching a tap number of a filter. It should be noted that although the example of FIG. 8A explains an example of processing using a smoothing filter (median filter) as the filter processing, processing using a filter having other frequency characteristics, such as a bandpass filter and the like, may be used.

In step S801 of FIG. 8A, region division processing for dividing an image of a subject into a plurality of regions is performed. In this context, each region is semantically segmented (semantic segmentation) based on a model that has been machine-learned in advance.

That is, in the present embodiment, a region division unit divides the image into a plurality of regions by semantic segmentation. However, the present embodiment is not limited only to semantic segmentation, and regions such as skin or hair regions and the like may be divided according to area and color in a face region, for example. That is, for example, in the face region, a region having a hue close to a color occupying a large area may be classified as skin.

It should be noted that in the present embodiment, each region is divided into, for example, organs such as eyes, nose, and mouth, organs other than these organs, hair, accessories, and the like, as exemplified in FIG. 8B. It should be noted that, for example, the image may be divided by classifying the image into organs and regions other than the organs.

It should be noted that in the present embodiment, organs include, for example, any of an eye, a nose, and a mouth. In addition, regions other than organs include any of skin, hair, and accessories. In addition, accessories include, for example, glasses or earrings. In addition, in this context, step S801 functions as a region division step (region division unit) of dividing the image into a plurality of regions by classifying objects in the image.

Next, in step S802, smoothing processing of the distance map is performed by using a smoothing filter. At this time, for each region of the image as described above, a size (tap number) of the smoothing filter for a region of the distance map corresponding to each region is changed. That is, in step S802, for example, a size (tap number) of the smoothing filter of the region of the distance map corresponding to organs and a size (tap number) of the smoothing filter of the region of the distance map corresponding to regions other than organs are set so as to be different from each other.

Specifically, for example, the size (tap number) of the smoothing filter of the region of the distance map corresponding to organs is made smaller than the size (tap number) of the smoothing filter of the region of the distance map corresponding to regions other than organs.

Next, in step S803, distance information (divided regions of the distance map) subjected to different smoothing filter processing is synthesized. In this context, step S803 functions as a synthesis step (synthesis unit) of synthesizing distance information (distance map) on which filter processing having different characteristics has been performed.

It should be noted that in step S802 of the present embodiment, the size (tap number) of the smoothing filter is changed between the region of the distance map corresponding to organs and the region of the distance map corresponding to regions other than organs. However, different sizes (tap numbers) of the smoothing filter may be set for each organ such as eyes, nose, and mouth, or for each of hair, glasses, and the like in the region of the distance map corresponding to each organ or each of hair, glasses, and the like.

In this manner, in the present embodiment, the image is divided into a plurality of regions in the image based on a result of image recognition of the image, and a size (tap number and the like) of the smoothing filter in distance information (region of the distance map) corresponding to each image region is changed for each region.

After the synthesis processing of step S803, the process proceeds to step S506. Subsequent steps S506 to S508 function as a 3D data generation processing step (3D data generation processing unit) of generating 3D data of the subject based on the distance information (distance map) synthesized in step S803 and the captured image.

In this manner, in the present embodiment, when 3D data is generated based on an image and a distance map, asperities can be strengthened for 3D data of a desired subject region, and asperities can be reduced for 3D data of an unnecessary subject region.

It should be noted that step S802 functions as a filter processing step (filter processing unit) that performs filter processing having different characteristics according to classification with respect to respective distance information (regions of a distance map) corresponding to a plurality of regions of an image.

It should be noted that the smoothing filter size (tap number and the like) may be configured to be arbitrarily settable by a user for each divided region that has been semantically segmented. Alternatively, a size (tap number and the like) of a smoothing filter may be automatically set based on machine learning for each divided region that has been semantically segmented.

As described above, according to the present embodiment, an image processing apparatus and the like that can reduce unnecessary asperities while producing asperities of a desired part when generating a stereoscopic image can be provided.

### Second Embodiment

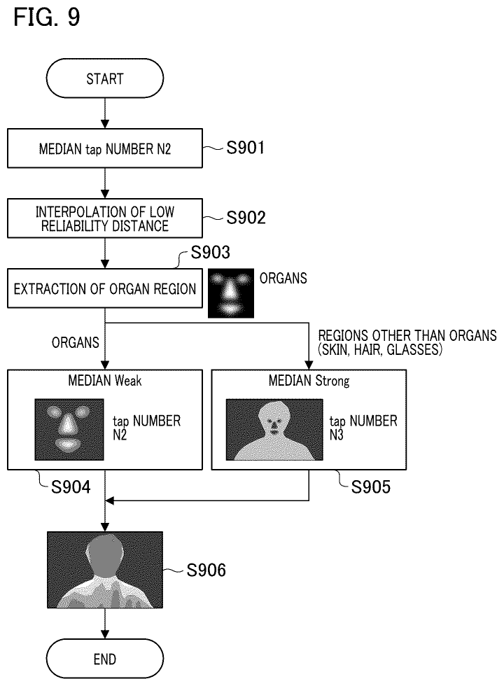

FIG. 9 is a flowchart showing an example of smoothing processing of step S505 according to the Second Embodiment of the present disclosure. In the Second Embodiment, an order of processing in smoothing processing of step S505 is different from the First Embodiment.

As shown in FIG. 9, in step S901, noise in a distance map is reduced by performing median filter processing having a tap number N2 (N2<N1). Next, in step S902, distance data having low reliability is interpolated by distance data around the distance data having low reliability. Thereafter, in step S903, region division processing for dividing an image of a subject into a plurality of regions is performed.

In the Second Embodiment also, each region is semantically segmented (semantic segmentation) based on a model that has been machine-learned in advance. It should be noted that in the Second Embodiment, each region is divided into, for example, organs such as eyes, nose, and mouth, and regions other than organs (for example, skin, hair, glasses, and the like).

Then, in step S904, for organs such as eyes, nose, and mouth, and the like, for example, weak median filter processing having a tap number N2 (N2<N1) is executed. In addition, in step S905, for example, for regions other than organs (for example, skin, hair, glasses, and the like), for example, strong median filter processing having a tap number N3 (N3>N1) is executed.

Then, an organ region that has been weakly smoothing-processed in step S904 and regions other than organs that have been strongly smoothing-processed in step S905 are synthesized in step S906. Thereafter, the smoothing processing of FIG. 9 is ended, and the processing proceeds to point cloud processing of step S506.

### Third Embodiment

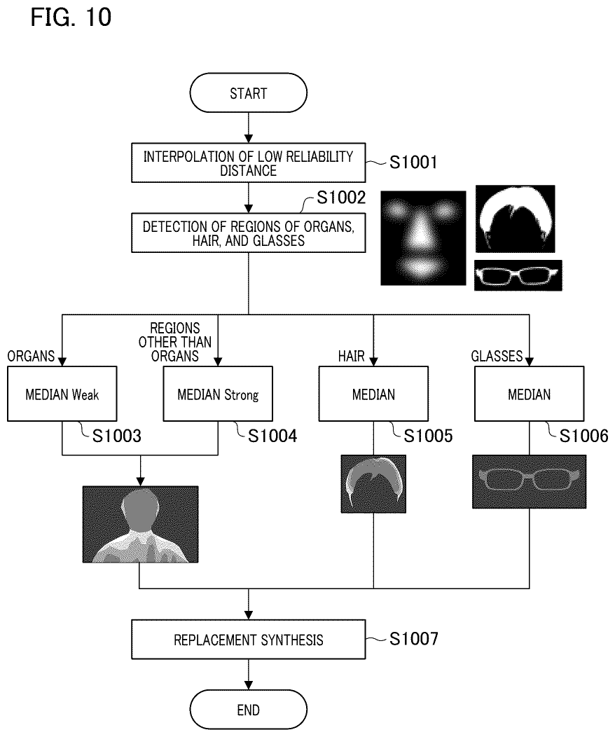

FIG. 10 is a flowchart showing an example of smoothing processing of step S505 according to the Third Embodiment of the present disclosure. In the present embodiment, different median filter processing is performed for each of organs, regions other than organs, hair, and glasses.

In step S1001, distance data having low reliability is interpolated by distance data around the distance data having low reliability, and in step S1002, region division processing for dividing an image of a subject into a plurality of regions is performed. In the Third Embodiment also, each region is semantically segmented (semantic segmentation) based on a model that has been machine-learned in advance.

It should be noted that in the Third Embodiment, each region is divided into organs such as eyes, nose, and mouth, and the like, regions other than organs (for example, skin), hair, and glasses. Then, in step S1003, weak median filter processing is performed for organs, and in step S1004, strong median filter processing is performed for regions other than organs (for example, skin).

In addition, in step S1005, for example, relatively weak median filter processing having characteristics different from other median filters is performed for hair. In addition, in step S1006, for example, relatively strong median filter processing having characteristics different from other median filters is performed for glasses.

For example, in the Third Embodiment, the tap number of the median filter may be set so that the tap number for skin is greater than the tap number for hair, which is greater than the tap number for organs, which is greater than the tap number for glasses. In this manner, for example, it is desirable to make the size of filter processing for organs smaller than the size of filter processing for skin.

In step S1007, processing results of steps S1003 to S1006 are replaced and synthesized. That is, processing results of step S1003 and step S1004 are synthesized, and the synthesis result is, for example, replaced by processing results of step S1005 and step S1006. Thereafter, the processing proceeds to step S506 of FIG. 5 by ending the processing flow of FIG. 10, and processing for 3D conversion is performed.

It should be noted that synthesis processing in step S1007 may be synthesis by addition or synthesis by replacement. In this manner, because the Third Embodiment performs median filter processing having characteristics different from other median filters for hair and glasses and the like, smoothing of each region in the 3D data can be optimized to a greater degree.

It should be noted that in the above-described embodiments, although an example of a distance map generated by using a CMOS image sensor of a phase difference detection method has been explained, the present disclosure is not limited thereto. The distance map may be generated by using a stereo camera, for example, or may be generated by using a TOF (Time Of Flight) sensor. In addition, machine learning (Deep Learning) and the like may be used for generating the distance map.

In addition, in the above-described embodiments, although an example of smoothing by using a median filter has been explained, a filter for smoothing need not be a median filter, and may be a filter having frequency characteristics such as a low-pass filter or a band-pass filter, and the like.

In addition, although an example of changing characteristics of a smoothing filter by changing a tap number has been explained, the present disclosure is not limited to changing of the tap number. For example, a desired smoothing characteristic may be realized by switching a plurality of filters having different frequency characteristics or by changing a combination method.

In addition, as a smoothing filter, because a frame of an accessory (glasses and the like) has a small number of rangefinding points, linear interpolation or replacement may be performed based on a representative value, for example, instead of smoothing. In addition, because a rangefinding value of a region of a division boundary has a large distance error (such as in a case in which a rangefinding value extends outside a window boundary, and the like), the rangefinding value may be configured so as not to be used in filter processing or to have a reduced weight.

In addition, since a nose, glasses, and the like have a shape that is determined to some extent, filter processing such as smoothing and the like may be performed based on predetermined average model information (distance information). In addition, whether or not to perform filter processing such as smoothing and the like by the First Embodiment or the Second Embodiment and the like may be controlled according to an image capturing distance or a size of a face. That is, for example, in a case in which an image capturing distance to a subject is equal to or less than a predetermined value, or in a case in which a size of a face is equal to or greater than a predetermined value, filter processing having different characteristics according to classification may be configured so as not to be performed.

In addition, even for the same organ, filter characteristics (tap number and the like) may be configured to be changed according to a direction of a face. This is because, for example, when viewed in an oblique direction, there are cases in which a size and a shape of left and right eyes and the like differ.

While the present disclosure has been described with reference to embodiments, it is to be understood that the disclosure is not limited to the disclosed embodiments but is defined by the scope of the following claims.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-106670, filed on Jul. 2, 2024.

What is claimed is:

1. An image processing apparatus comprising:
at least one processor or circuit configured to function as:
a region division unit configured to divide an image into a plurality of regions by classifying objects;
a filter processing unit configured to perform, with respect to respective distance information corresponding to the plurality of regions of the image, filter processing having different characteristics according to the classification;
a synthesis unit configured to synthesize the distance information on which the filter processing has been performed; and
a 3D data generation processing unit configured to generate 3D data of a subject based on the distance information synthesized by the synthesis unit and the image.

2. The image processing apparatus according to claim 1, wherein the at least one processor or circuit is further configured to function as:
an information acquisition unit configured to acquire the image and the distance information.

3. The image processing apparatus according to claim 2, wherein the information acquisition unit is configured to acquire the image and the distance information from an image capturing element.

4. The image processing apparatus according to claim 2, wherein the information acquisition unit is configured to acquire the image and the distance information from an image recording unit.

5. The image processing apparatus according to claim 1, wherein the filter processing unit is configured to perform the filter processing having different characteristics with respect to the respective distance information by switching a tap number of a filter.

6. The image processing apparatus according to claim 1, wherein the filter processing includes processing using a smoothing filter.

7. The image processing apparatus according to claim 6, wherein the filter processing includes processing using a median filter.

8. The image processing apparatus according to claim 1, wherein the region division unit is configured to divide the image by classifying the image into organs and regions other than the organs.

9. The image processing apparatus according to claim 8, wherein the organs include any of an eye, a nose, and a mouth.

10. The image processing apparatus according to claim 8, wherein the regions other than the organs include any of skin, hair, and accessories.

11. The image processing apparatus according to claim 10, wherein the accessories include glasses or earrings.

12. The image processing apparatus according to claim 1, wherein the region division unit is configured to divide the image into the plurality of regions by semantic segmentation.

13. The image processing apparatus according to claim 1, wherein the region division unit is configured to divide skin regions or hair regions according to area and color in a face region.

14. The image processing apparatus according to claim 1, wherein the filter processing unit is configured to set a size of the filter processing for organs smaller than a size of the filter processing for skin.

15. The image processing apparatus according to claim 1, wherein the filter processing unit is configured to perform linear interpolation or replacement using a representative value for accessories.

16. The image processing apparatus according to claim 1, wherein the filter processing unit is configured either not to use rangefinding values of regions of division boundaries in the filter processing or to reduce weights of the rangefinding values.

17. The image processing apparatus according to claim 1, wherein the filter processing unit is configured to perform filter processing for a nose or glasses based on predetermined model information.

18. The image processing apparatus according to claim 1, wherein the filter processing unit is configured to control whether or not to perform the filter processing according to an image capturing distance or a size of a face.

19. The image processing apparatus according to claim 1, wherein the filter processing unit is configured to change filter characteristics even for a same organ according to a direction of a face.

20. An image processing method comprising:
dividing an image into a plurality of regions by classifying objects;
performing filter processing having different characteristics according to the classification with respect to respective distance information corresponding to the plurality of regions of the image;
synthesizing the distance information on which the filter processing has been performed; and
generating 3D data of a subject based on the synthesized distance information and the image.

21. A non-transitory computer-readable storage medium storing a computer program including instructions for executing the following processes:
dividing an image into a plurality of regions by classifying objects;
performing filter processing having different characteristics according to the classification with respect to respective distance information corresponding to the plurality of regions of the image;
synthesizing the distance information on which the filter processing has been performed; and
generating 3D data of a subject based on the synthesized distance information and the image.
